(19) United States
(12) Patent Application Publication
(10) Pub. No.: US 2006/0191671 A1
(43) Pub. Date: Aug. 31, 2006

(54) Heat exchanger and method for treating the surface of said heat exchanger

(75) Inventors: Snjezana Boger, Esslingen (DE); Peter Englert, Friedrichshall (DE); Klaus Fischle, Tamm (DE); Oliver Mamber, Stuttgart (DE); Sabine Sedlmei_R, Mosbach (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 10/551,181

(22) PCT Filed: Mar. 8, 2004
(86) PCT No.: PCT/EP04/02337

§ 371 Date: Sep. 29, 2005

(30) Foreign Application Priority Data
Mar. 31, 2003 (DE) 103 14 701.2

(51) Int. Cl. F28F 13/18; B05D 1/12

(52) U.S. Cl. 165/133; 427/180

(57) ABSTRACT

The invention relates to a heat exchanger provided with, a hydrophilic surface (2) comprising nanoparticles (3), coated and/or grafted nanoparticles consisting of or containing oxides.

The invention relates to a heat exchanger, in particular for a motor vehicle, as described in the preamble of claim 1 and to a process for the surface treatment of a heat exchanger.

In conventional heat exchangers, there are often problems with corrosion, microbiological growth and dirt. These problems are caused, inter alia, by the precipitation of condensate from the air which is flowing through the sets of corrugated fins which are arranged between the plates or tubes through which refrigerant flows. Furthermore, there is also an accumulation of dust and dirt, which means that microorganisms can colonize the wet, dirty surface, which can Lead to the formation of undesirable odors.

The flow of condensate off the surface can be boosted by making the surface of the heat exchanger hydrophilic, the hydrophilicity forming a thin film of liquid which can continuously flow off the corrugated fin surface. This leads to a so-called self-cleaning effect or rinsing effect, making it possible to reduce permanent accumulation of dust and dirt and to avoid colonization of microorganisms on the surface of the heat exchanger. Furthermore, the corrugated fin surface dries more quickly. This maintains or improves the overall performance of the heat exchanger.

EP 115 40 42 A1 has disclosed an agent for the chemical surface treatment of heat exchangers, in which silicate particles with a mean diameter of from 5 to 1000 nm and polyvinyl alcohol are applied in aqueous solution to the surface of heat exchangers. To pretreat the surface, the surface is first of all subjected to an acidic cleaning step and then a chromium-containing or zirconium-containing conversion layer is built up. The heat exchanger which has been prepared in this way is coated with the abovementioned hydrophilic chemicals, so that the correspondingly treated surface has hydrophilic properties.

It is an object of the invention to provide an improved heat exchanger.

This object is achieved by a heat exchanger having the features of claim 1. Advantageous configurations form the subject matter of the subclaims.

According to the invention, a heat exchanger, in particular a heat exchanger for a motor vehicle, is provided, having a preferably hydrophilic surface coating which contains nanoparticles, coated nanoparticles and/or grafted nanoparticles. A hydrophilic surface coating ensures that a thin, continuous film of liquid is formed on the surface and can continuously flow off the corrugated fin surface or off the plates/tubes of the heat exchanger. This leads to a self-cleaning effect or rinsing effect, allowing a permanent accumulation of dust and dirt to be reduced and a colonization of microorganisms on the surface of the heat exchanger to be avoided. Furthermore, the corrugated fin surface dries more quickly.

In modified embodiments of the invention, the surface coating, in addition or instead of the hydrophilic action, has one or more other advantageous actions, such as for example a corrosion-inhibiting or corrosion-preventing action.

It is preferable for the nanoparticles to comprise approximately 100% or entirely oxides.

In the case of the coated nanoparticles, it is also possible for other compounds to be present in the coating instead of or in addition to oxides, which are provided at least in the core of the coated nanoparticles. The coating of the nanoparticles may include organic and/or inorganic components, as well as organic and/or inorganic components with an antimicrobial action.

The grafted nanoparticles are nanoparticles with a core comprising or consisting of oxides which carry side groups. These side groups are chemically bonded to the surface of the nanoparticle core, e.g. by oxygen or nitrogen bridges. By way of example, bifunctional compounds, e.g. diamines and/or dialcohols, are used to produce nanoparticles of this type. As a result, the surface properties of a nanoparticle can be varied (e.g. made hydrophobic, hydrophilic, stabilized in the dispersion or solution). Moreover, it is possible for a polymer chain with a reactive side chain which, for example, contains an OH or COOH or OR group, or a reactive group which has not fully reacted in the polymer network, e.g. OH or COOH or OR, to be grafted onto the nanoparticle.

Unless expressly stated to the contrary, it is preferable for the nanoparticles (in the text which follows, this term is also to be understood as encompassing coated and/or grafted nanoparticles, for the sake of simplicity) to contain oxides and/or hydrated oxides and/or nitrides, and/or carbides. In this context, it is preferable to provide oxides of the element from main group II and/or III and/or oxides of germanium, tin, lead, and oxides of the transition metals, preferably from transition group IV and V and/or oxides of zinc and/or oxides of cerium.

The hydrated oxides, nitrides and carbides preferably comprise elements from main group II and/or main group III and/or main group IV and/or transition metals, preferably from transition group IV and V, and/or zinc and/or cerium.

The nanoparticles are preferably contained in an aqueous dispersion or solution, which contains a preferably organic binder, and/or in a dispersion or solution based on organic dispersants or solvents, which contains a preferably organic binder, or in a sol, which can function as coating material in a sol-gel coating.

In the case of a sol, alkoxy compounds of elements from main group III, i.e. for example aluminum, boron, indium, and/or of elements from main group IV, i.e. for example silicon, tin, and/or of transition metals, preferably from transition group IV, such as titanium, zirconium, hafnium, and/or from transition group V, such as vanadium, niobium, tantalum, are preferably contained.

In the alkoxy compounds, it is preferable for some of the hydrolysable alkoxy radicals to be substituted by alkyl and/or aryl radicals or else it is preferable to provide a mixture of pure alkoxy compounds and alkoxy compounds which partly contain alkyl and/or aryl radicals. These compounds are preferably halogenated, particularly preferably fluorinated.

It is preferable for the nanoparticles, coated nanoparticles and the grafted nanoparticles to have a mean diameter of from 1 to 1000 nm, in particular between 50 and 500 nm.

It is preferable for the surface coating to include constituents with an antimicrobial action. These may form part of the nanoparticles, for example in the case of grafted or coated nanoparticles, or may be contained in the remaining part of the surface coating. Additives of this type improve the antimicrobial action of the surface coating and prevent colonization of microorganisms on the surface of the heat exchanger or at least impede such colonization.

It is preferable for the surface coating to be applied by means of dipping, flooding or spraying.

It is preferable to carry out a pre-treatment by means of an acidic or alkaline pickle with subsequent scale removal and/or a conversion treatment. This pre-treatment is also preferably carried out by means of dipping, flooding or spraying. The conversion treatment is used to build up passivation layers which form a very firm bond to the surface, for example by forming mixed oxides. A passivation layer of this type inter alia prevents corrosive attack.

A drying operation may be carried out after the pre-treatment, and a drying operation is necessary after the actual surface coating.

The invention is explained in detail below on the basis of two exemplary embodiments, with reference to the drawing. In the drawing:

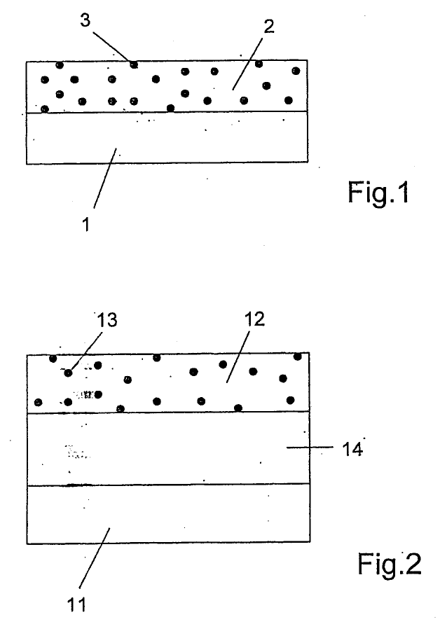

FIG. 1 shows a section through the region of a heat exchanger close to the surface with a coating in accordance with a first exemplary embodiment of the invention, and

FIG. 2 shows a section through the region of a heat exchanger close to the surface with a coating in accordance with a second exemplary embodiment of the invention.

FIG. 1 shows the region of a corrugated finned metal sheet 1 of a heat exchanger made from aluminum close to the surface in accordance with a first exemplary embodiment, which is provided with a hydrophilic surface coating 2. In this case, this surface coating 2 is formed from a sol which contains nanoparticles 3 comprising substantially pure aluminum oxide. The nanoparticles 3 have a mean diameter of between 10 and 100 nm and are distributed relatively uniformly through the entire surface coating 2.

The sol includes alkoxy compounds of aluminum, a mixture of -pure alkoxy compounds and alkoxy compounds in which some of the hydrolysable alkoxy radicals are substituted by alkyl radicals being used.

The surface coating 2 is applied following a surface cleaning using an acidic pickle, by dipping in a colloidal sol solution in which nanoparticles of aluminum oxide are dispersed. This is followed by a drying process.

FIG. 2 shows a region of a corrugated finned metal sheet 11 of a heat exchanger close to the surface in accordance with a second exemplary embodiment. In this case, a conversion layer 14 is provided between a hydrophilic surface coating 12 which contains nanoparticles 13. The conversion layer 14 includes, inter alia, mixed oxides of aluminum and zirconium.

The nanoparticles 13 are what are known as grafted nanoparticles which carry side groups. In this case, the nanoparticles 13 contain an oxide-containing core which is surrounded by bifunctional organic compounds which are chemically bonded to the surface of the nanoparticle core. The bifunctional organic compounds include, inter alia, side groups with an antimicrobial action. The actual surface coating 12 comprises an organic matrix which contains an organic binder. This organic matrix is built up from an organic dispersion or solution in which the grafted nanoparticles 13 are distributed. The oxide-containing core of the grafted nanoparticles 13 substantially comprises zirconium dioxide and titanium dioxide.

To prepare the surface for the application of the actual surface coating 13, the surface is provided with the conversion layer 14, which contains mixed oxides of aluminum and zirconium. For this purpose, a zirconium-containing chemical is applied by means of dipping, and mixed oxides of aluminum and zirconium are formed, so as to produce a very secure bond to the surface.

The surface coating 12 can be applied following a drying operation. The surface coating 12 is applied by dipping in a dispersion containing the nanoparticles 13. This is followed by a further drying process.

1. A heat exchanger having an in particular hydrophilic surface coating, characterized in that the surface coating contains nanoparticles, coated nanoparticles and/or grafted nanoparticles comprising or consisting of oxides.

2. The heat exchanger as claimed in claim 1, characterized in that oxides of the elements from main group II and/or main group III and/or oxides of germanium, tin, lead and/or oxides of the transition metals and/or oxides of zinc and/or oxides of cerium are provided.

3. The heat exchanger as claimed in claim 1, characterized in that the surface coating contains nanoparticles, coated nanoparticles and/or grafted nanoparticles comprising or consisting of hydrated oxides and/or nitrides and/or carbides.

4. The heat exchanger as claimed in claim 3, characterized in that the hydrated oxides, nitrides and carbides comprise elements from main group III and/or main group IV and/or transition metals and/or cerium.

5. The heat exchanger as claimed in claim 4, characterized in that a transition metal belongs to transition group IV and/or V or is zinc.

6. The heat exchanger as claimed in claim 1, characterized in that the nanoparticles, coated nanoparticles and/or grafted nanoparticles are contained in an aqueous dispersion or solution, which contains a preferably organic binder, and/or in a dispersion or solution based on organic dispersants or solvents, which contains a preferably organic binder, or in a sol, which is used as coating material in a sol-gel coating.

7. The heat exchanger as claimed in claim 6, characterized in that the sol contains alkoxy compounds of elements from main group III and/or of elements from main group IV and/or of transition metals.

8. The heat exchanger as claimed in claim 7, characterized in that the transition metals belong to transition group IV or V.

9. The heat exchanger as claimed in claim 8, characterized in that in the alkoxy compounds some of the hydrolysable alkoxy radicals are substituted by alkyl and/or aryl radicals, or in that a mixture of pure alkoxy compounds and alkoxy compounds which partly contain alkyl and/or aryl radicals is provided.

10. The heat exchanger as claimed in claim 1, characterized in that the nanoparticles, coated nanoparticles and/or grafted nanoparticles have a mean diameter of from 1 to 1000 nm.

11. The heat exchanger as claimed in claim 1, characterized in that the surface coating includes constituents with an antimicrobial action.

12. A process for coating a heat exchanger with a hydrophilic surface coating, comprising applying a surface coating which contains at least one of the group consisting of nanoparticles, coated nanoparticles and grafted nanoparticles (13) as defined in claim 1.

13. The process for coating a heat exchanger as claimed in claim 12, characterized in that the surface coating is applied by means of dipping, flooding and/or spraying.

14. The process for coating a heat exchanger as claimed in claim 12, characterized in that a pre-treatment by means of an acidic or alkaline pickle is carried out, with subsequent scale removal and/or a conversion treatment.

15. The process for coating a heat exchanger as claimed in claim 14, characterized in that mixed oxides and/or mixed fluorides are formed during the conversion treatment.

16. The process for coating a heat exchanger as claimed in claim 12, characterized in that a drying process is carried out after a pre-treatment by means of an acidic or alkaline pickle with subsequent scale removal and/or a conversion treatment.

17. The process for coating a heat exchanger as claimed in claim 12, characterized in that the operation of applying the surface coating is followed by a drying operation.
